(19) United States
(12) Patent Application Publication
(10) Pub. No.: US 2016/0233769 A1
(43) Pub. Date: Aug. 11, 2016

(54) THREE-LEVEL SEPIC CONVERTER CIRCUIT

(71) Applicant: INDUSTRIAL COOPERATION FOUNDATION CHONBUK NATIONAL UNIVERSITY, Jeonju-si (KR)

(72) Inventors: Woo-Young CHOI, Jeonju-si (KR); Yong Cheol KANG, Jeonju-si (KR)

(21) Appl. No.: 14/750,798

(22) Filed: Jun. 25, 2015

(30) Foreign Application Priority Data
Feb. 9, 2015 (KR) 10-2015-0019188

(51) Int. Cl. H02M 3/158

(52) U.S. Cl. CPC H02M 3/158

(57) ABSTRACT

A three-level SEPIC converter circuit includes: an input inductor connected to one side of an input terminal; first and second switches connected between the input inductor and the other side of the input terminal in series; a first capacitor and a first diode connected between the first switch and one side of an output terminal in series; a second diode and a second capacitor connected between the other side of the output terminal and the other side of the input terminal in series; first and second output capacitors connected between the output terminals; and an output inductor connected between a node between the first capacitor and the first diode and a node between the second capacitor and the second diode, wherein a node between the first switch and the second switch and a node between the first output capacitor and the second output capacitor are connected.

### BACKGROUND OF THE INVENTION

1. Field of the Invention

The present invention relates to a converter circuit, and more particularly, to a converter circuit which reduces voltage stress inside a converter and improves power conversion efficiency.

2. Background Art

Almost all electronic communication devices, such as electronic calculators, electronic exchangers and so on, generally use a switched-mode power supply (SMPS) as a power supply part to supply stable DC power to an electronic circuit part. A DC-DC converter is an important part to define characteristics of such an SMPS, and kinds of the SMPSs are determined according to kinds of converters.

Now, the DC-DC converters mainly feature pulse width modulation (PWM) converters, and the PWM converters are divided into uninsulated DC-DC converters that input and output are not electrically insulated and insulated DC-DC converters that a first side and a second side of a transformer are electrically insulated.

The insulated DC-DC converters are divided into a forward type to transfer energy when a switch is turned on and a flyback type to transfer energy when a switch is turned off. However, such insulated DC-DC converters are limited in transformer utilization rate because energy of the first side of the transformer is transferred to the output of the second side of the transformer only when the switch is turned on or off.

Of course, there are forward-flyback converters which can transfer energy to the second side when the switch is turned on and turned off, but, there is a difficulty due to the nature of two different power circuits in composing and controlling a system at single output because the forward mode is a buck converter having input DC voltage (Vin) which is always greater than output DC voltage (Vo) and the flyback mode is a boost converter having input DC voltage (Vin) which is always smaller than output DC voltage (Vo).

The following prior art 1 has proposed a new type single ended primary inductor converter (SEPIC) flyback converter which can transfer energy flowing to the first side of a transformer to an output using a SEPIC mode circuit of the second side of the transformer when a switch is turned on (D) and transfers energy to the output using a flyback mode circuit of the second flyback mode of the transformer when the switch is turned off (1-D), thereby transferring energy to the second side of the transformer not only when the switch is turned on but also when the switch is turned off and greatly increasing transformer utilization rate and output.

The SEPIC converter includes inductors which are respectively mounted at an input terminal and an output terminal to make input and output current ripple characteristics excellent. Moreover, the SEPIC converter is used for power factor correction and as a power converter for various industries, such as a voltage regulator module, because output voltage can be higher or lower than input voltage. However, the conventional SEPIC converter applies high voltage stress to a power semiconductor while switching. The high voltage stress reduces power conversion efficiency of the SEPIC converter and degrades stability of the circuit.

Referring to FIGS. 1 and 2, problems of the conventional SEPIC converter will be described in more detail. FIG. 1 is a circuit diagram of the conventional SEPIC converter, and FIG. 2 is a graph showing voltage applied to a switch and a diode as time goes by in a case that the switch of the conventional SEPIC converter is controlled by a duty cycle D.

The conventional SEPIC converter includes an input inductor (Li), a switch (S1), a capacitor (Ci), an output inductor (Lo), an output diode (Do) and an output capacitor (Co). The SEPIC converter includes the input inductor (Li) disposed at an input terminal and the output inductor (Lo) disposed at an output terminal. In FIG. 1, when the switch (S1) is turned on, the output diode (Do) is open. In this instance, voltages applied to the switch (S1) and the output diode (Do) become Vci+Vo. In the meantime, when the switch (S1) is turned off, the output diode (Do) is short-circuited, and voltage applied to the switch (S1) becomes Vci+Vo.

In a steady state of the conventional SEPIC converter (the inductor is short-circuited and the capacitor is open in a case of DC steady state), capacitor voltage (Vci) becomes input voltage (Vi). As shown in FIG. 2, in the conventional SEPIC converter, voltages applied to the switch (S1) and the output diode (Do) become Vi+V0. Therefore, if the input voltage (Vi) and the output voltage (Vo) are high, switching power loss increases because of high voltage stress. The switching power loss due to the high voltage stress lowers power conversion efficiency of the SEPIC converter and degrades stability of the circuit.

### SUMMARY OF THE INVENTION

Accordingly, the present invention has been made to solve the above-mentioned problems occurring in the prior arts, and it is an object of the present invention to provide a three-level SEPIC converter circuit which reduces voltage stress of switches and diodes of a SEPIC converter and improves power conversion efficiency.

To accomplish the above object, according to the present invention, there is provided a three-level SEPIC converter circuit including: an input inductor which is connected to one side of an input terminal; first and second switches which are connected between the input inductor and the other side of the input terminal in series; a first capacitor and a first diode which are connected between the first switch and one side of an output terminal in series; a second diode and a second capacitor which are connected between the other side of the output terminal and the other side of the input terminal in series; first and second output capacitors which are connected between the output terminals; and an output inductor which is connected between a node between the first capacitor and the first diode and a node between the second capacitor and the second diode, wherein a node between the first switch and the second switch and a node between the first output capacitor and the second output capacitor are connected.

In the meantime, the three-level SEPIC converter circuit further includes a control part for controlling on/off states of the first switch or the second switch. In this instance, the control part turns on or off the first switch and the second switch on a previously set cycle, or controls the first switch and the second switch in such a way that there is a difference of a half cycle between the time that the first switch is turned on or off and the time that the second switch is turned on or off.

In preferred embodiments of the present invention, the control part may control the interval of on-state duration of the first switch and the second switch to be less than a half cycle, or may control the interval of on-state duration of the first switch and the second switch to be more than a half cycle and less than one cycle.

Meanwhile, the first capacitor may be connected to the first switch and the first diode may be connected to one side of an output terminal, and especially, an anode of the first diode is connected to the first capacitor and a cathode of the first diode is connected to one side of the output terminal. Moreover, the second capacitor may be connected to the second switch and the second diode may be connected to the other side of the output terminal, and especially, an anode of the second diode is connected to the other side of the output terminal and a cathode of the second diode is connected to the second capacitor.

In the present invention, the first capacitor and the second capacitor may be composed of elements with the same capacity, and the first output capacitor and the second output capacitor may be composed of elements with the same capacity.

According to the present invention, the three-level SEPIC converter circuit can reduce voltage stress of the switches and the diodes of the three-level SEPIC converter and improve power conversion efficiency.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a circuit diagram of a conventional converter circuit;

FIG. 2 is a graph showing voltages of a diode and a switch according to operation of the switch in the conventional converter circuit;

FIG. 3 is a circuit diagram of a three-level SEPIC converter circuit according to a first preferred embodiment of the present invention;

FIG. 4 is a circuit diagram of a three-level SEPIC converter circuit according to a second preferred embodiment of the present invention;

FIGS. 5 and 6 are graphs showing voltages of diodes and switches according to operations of the switches in the three-level SEPIC converter circuit according to the preferred embodiment of the present invention;

FIGS. 7A-7D and 8A-8D are views showing an equivalent circuit according to operations of the switches in the three-level SEPIC converter circuit according to the preferred embodiment of the present invention; and

FIG. 9 is a view showing an equivalent circuit in a steady state of the three-level SEPIC converter circuit according to the preferred embodiment of the present invention.

### DETAILED DESCRIPTION OF THE PREFERRED EMBODIMENT

Hereinafter, referring to the attached drawings, a three-level SEPIC converter circuit according to the present invention will be described in detail as follows. However, it would be understood that the preferred embodiments disclosed in the present invention are to describe the present invention in detail in such a manner that those skilled in the art can easily execute the present invention but the technical idea and scope of the present invention are not limited by the preferred embodiments. Moreover, matters illustrated in the attached drawings are schematized in order to lucidly explain preferred embodiments of the present invention, but may be different from forms actually realized.

Meanwhile, it will be understood that terms, such as ‘include’, in the specification are ‘open type’ expressions used to mean that there are the corresponding components described in the specification and there is no intent to exclude existence or possibility of other components.

Furthermore, it will be understood that terms, such as “first” or “second”, in the specification are used to discriminate one component from another component and do not restrict specific order between components or other characteristics.

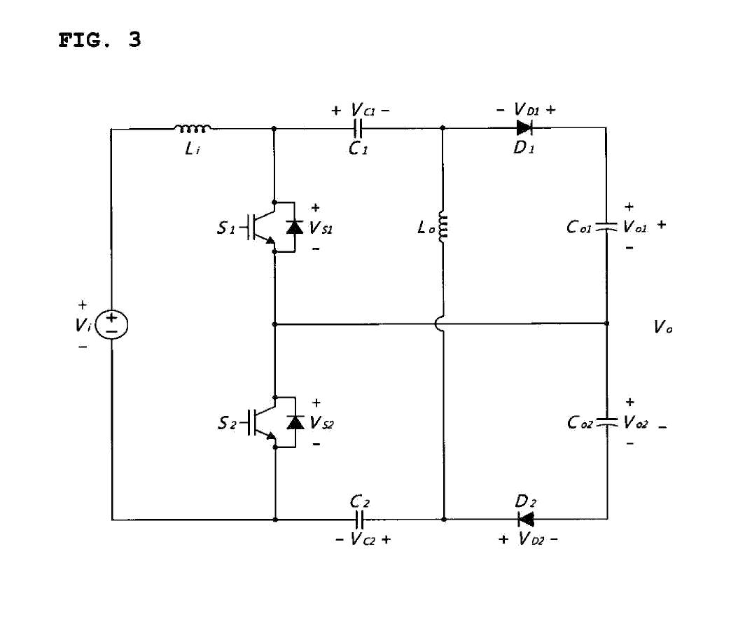

FIG. 3 is a circuit diagram of a three-level SEPIC converter circuit according to a first preferred embodiment of the present invention.

The three-level SEPIC converter circuit according to the preferred embodiment of the present invention includes: an input inductor which is connected to one side of an input terminal; first and second switches which are connected between the input inductor and the other side of the input terminal in series, a first capacitor and a first diode which are connected between the first switch and one side of an output terminal in series; a second diode and a second capacitor which are connected between the other side of the output terminal and the other side of the input terminal in series; first and second output capacitors which are connected between the output terminals; and an output inductor which is connected between a node between the first capacitor and the first diode and a node between the second capacitor and the second diode, wherein a node between the first switch and the second switch and a node between the first output capacitor and the second output capacitor are connected.

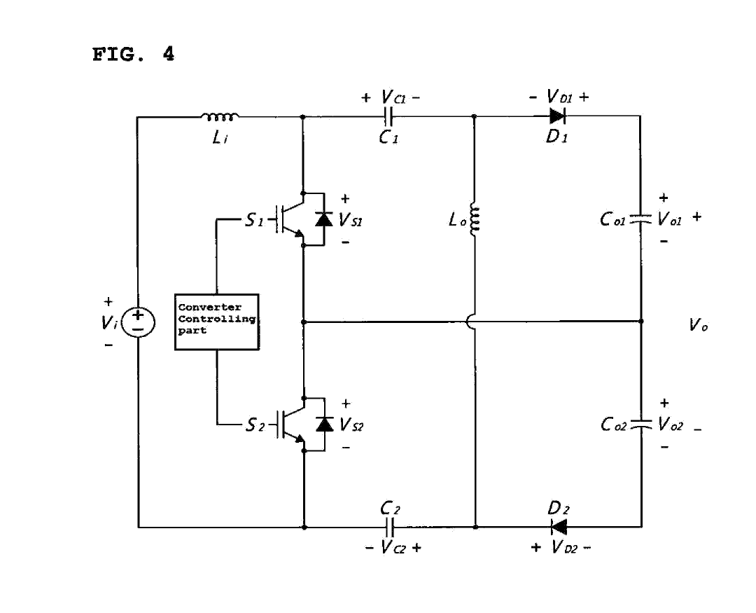

FIG. 4 is a circuit diagram of a three-level SEPIC converter circuit according to a second preferred embodiment of the present invention. In this embodiment, the converter circuit further includes a control part for controlling the on/off states of the first switch or the second switch. According to a control command of the control part, operations of the first switch and the second switch are controlled. The first switch and the second switch may be in an on state or an off state on various cycles at various intervals of duration according to control of the control part. The control part can be realized by various configurations which can control the switches according to inputted control commands or previously set control commands. For instance, the control part may be realized by analog/digital semiconductor devices.

In the first preferred embodiment of the present invention, the control part can turn on or off the first switch and the second switch on a previously set cycle. Particularly, as the previously set cycle, the first switch and the second switch may have the same cycle. That is, the time (Ts1) required from the moment the first switch is turned off to the moment the first switch is turned off again after being turned on may have the same setting as the time (Ts2) required from the moment the second switch is turned off to the moment the second switch is turned off again after being turned on According to the above setting, the control part can control the first switch and the second switch.

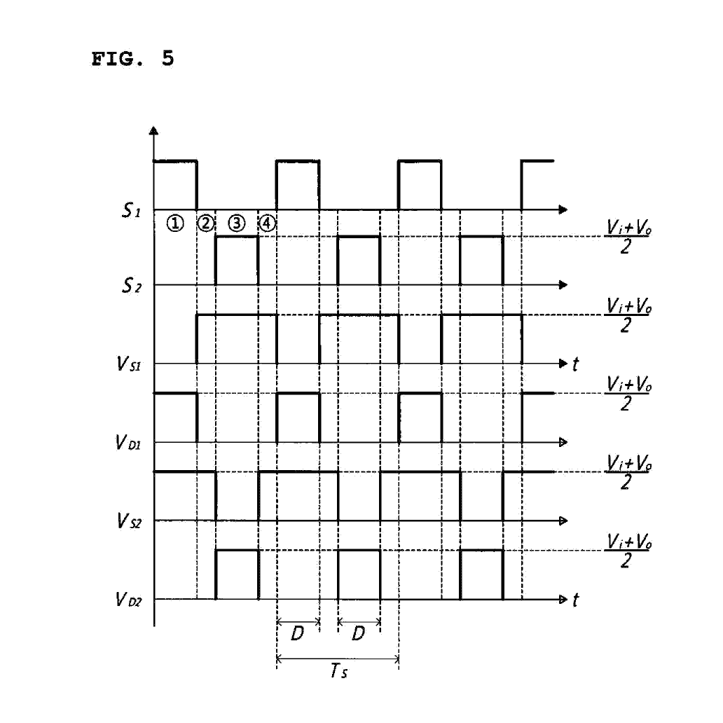

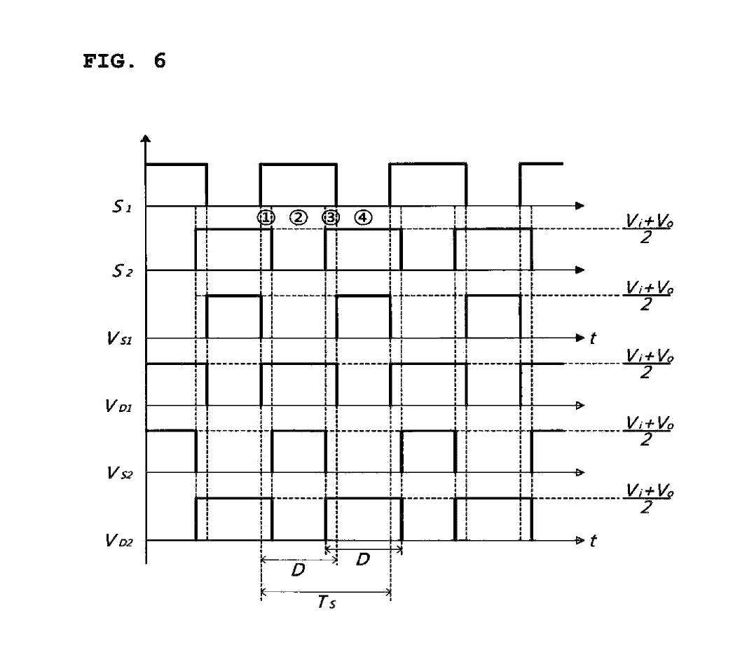

Particularly, in the first preferred embodiment of the present invention, the control part can control the first switch and the second switch in such a way that there is a difference of a half cycle between the time that the first switch is turned on or off and the time that the second switch is turned on or off. Operation due to the difference of a half cycle between the first switch and the second switch will be described later referring to FIGS. 5 and 6.

In the second preferred embodiment of the present invention, the first capacitor may be connected to the first switch, and the first diode may be connected to one side of the output terminal. Especially, the anode of the first diode is connected to the first capacitor and the cathode of the first diode is connected to one side of the output terminal. The diode is a directional element and has different effects on the operation of the whole circuit according to connection directions. In the present invention, if the diode is connected in the same structure as this embodiment, it can reduce voltage stress applied to the switch and the diode.

Additionally, in the second preferred embodiment of the present invention, the second capacitor may be connected to the second switch and the second diode may be connected to the other side of the output terminal, and in this instance, the anode of the second diode may be connected to the other side of the output terminal and the cathode of the second diode may be connected to the second capacitor. FIG. 3 is a circuit diagram showing the converter circuit having the above configuration.

Hereinafter, referring to FIGS. 5 and 6, operations of the switches according to control of the control part and voltages applied to the switch and the diode by the operations of the switch will be described.

FIGS. 5 and 6 are graphs showing voltages of diodes and switches according to operations of the switches in the three-level SEPIC converter circuit according to the first preferred embodiment of the present invention. FIG. 5 shows a state where a duty cycle (D) is less than 0.5, and FIG. 6 shows a state where the duty cycle (D) exceeds 0.5.

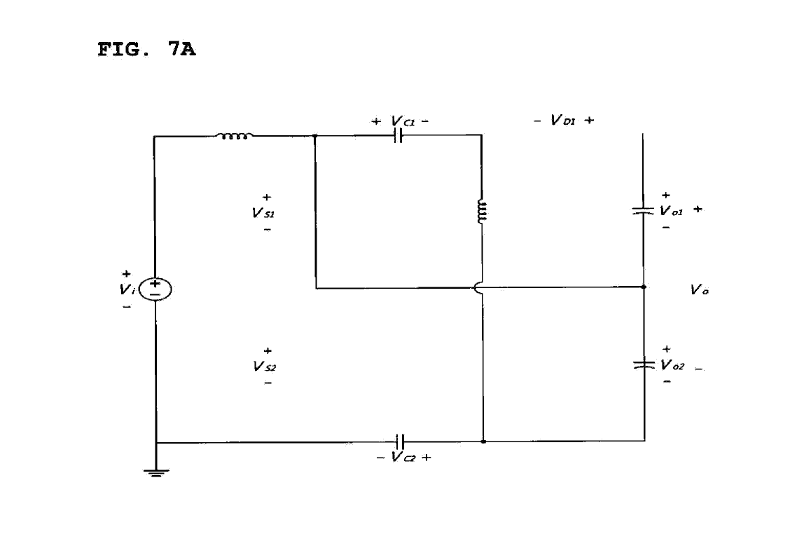

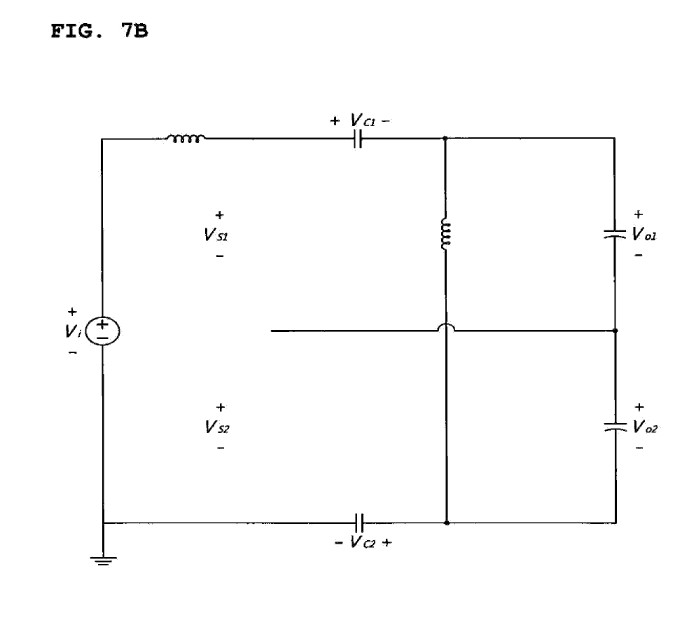

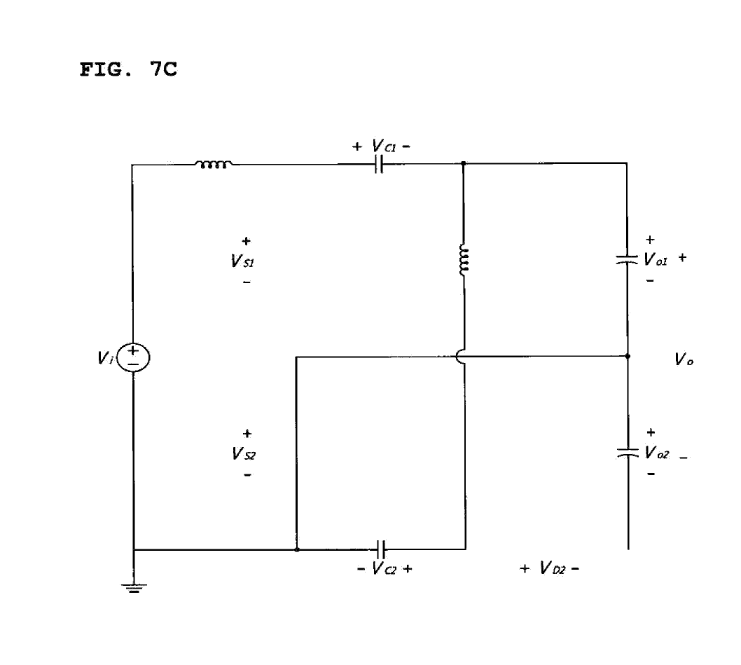

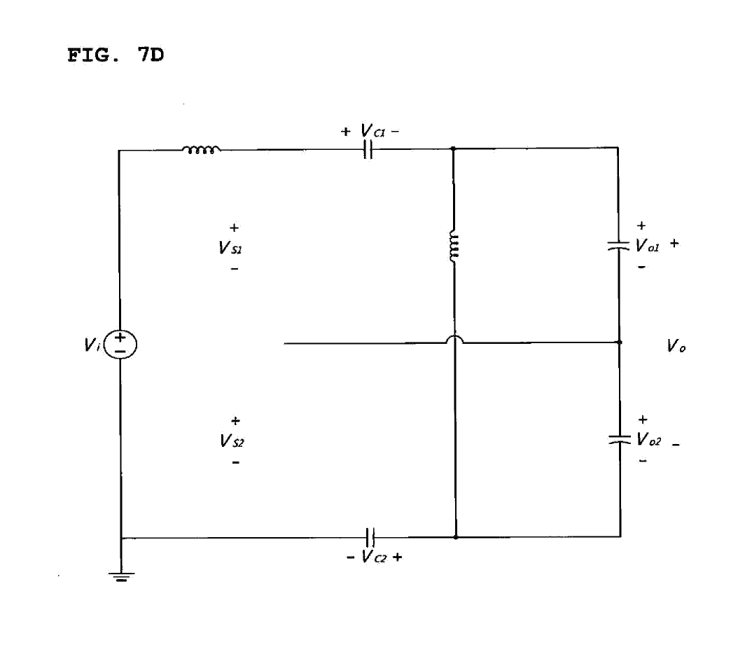

In the preferred embodiment shown in FIG. 5, the interval of on-state duration of the first switch and the second switch is less than a half cycle. In FIG. 5, at the time \textcircled{1}, the first switch is turned on, but the second switch is turned off. In this instance, operation of the three-level SEPIC converter circuit is as follows. The first diode is open and the second diode is short-circuited. FIG. 7A shows the above state. In FIG. 7A, voltages applied to the first and second switches and the first and second diodes are as follows.

Vs1=0

Vs2=Vc2+Vo2

VD1=Vc1+Vo1

VD2=0

Because the first switch and the second diode are short-circuited, voltage becomes zero and the voltage with the above-mentioned size in comparison with voltage of each element of the whole circuit is applied to the second switch and the second diode.

At the time \textcircled{2}, the first switch is turned off, but the second switch is also turned off. In the meantime, in the above switched state, the first diode and the second diode are all short-circuited. FIG. 7B shows the above state. In this instance, voltages applied to the first and second switches and the first and second diodes are as follows.

Vs1=Vc1+Vo1

Vs2=Vc2+Vo2

VD1=0

VD2=0

Because the first and second diodes are all short-circuited, voltages at both ends of the diodes become zero and voltages applied to the first and second switches are the same as the above-mentioned expression.

At the time \textcircled{3}, the first switch keeps the off state and the second switch is converted into the on state. In this instance, the first diode is short-circuited and the second diode is operated in an open state. FIG. 7C shows a circuit diagram of the above state. In this instance, voltages applied to the first and second switches and the first and second diodes are as follows.

Vs1=Vc1+Vo1

Vs2=0

VD1=0

VD2=Vc2+Vo2

At the time \textcircled{4}, the first switch keeps the off state and the second switch is converted into the off state. In this instance, like the time \textcircled{2}, the first and second diodes are all short-circuited. Voltages applied to the first and second switches and the first and second diodes are as follows.

Vs1=Vc1+Vo1

Vs2=Vc2+Vo2

VD1=0

VD2=0

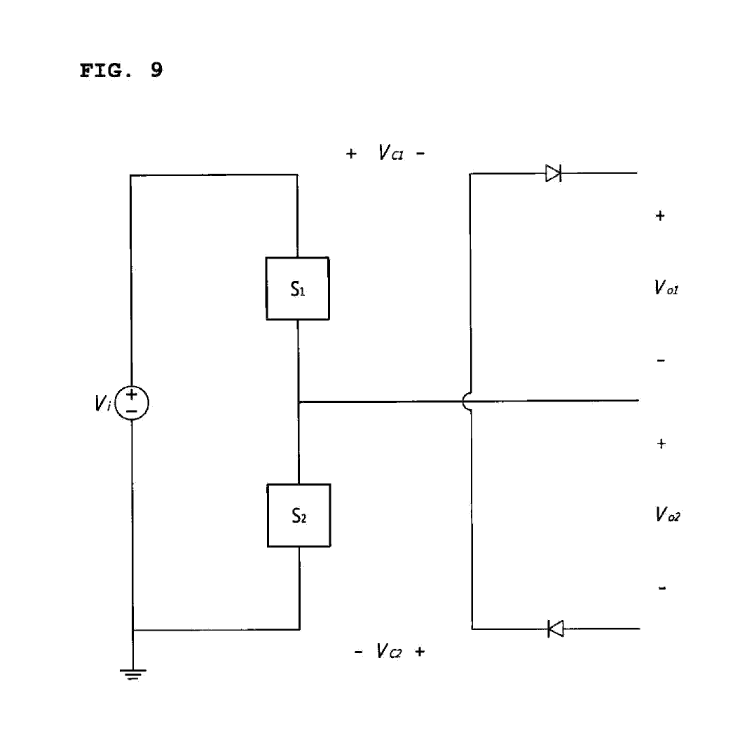

Vs1, Vs2, VD1 and VD2 from the time \textcircled{1} to the time \textcircled{4} are 0 or Vc1+Vo1 or Vc2+Vo2. Voltages applied to the switches and both ends of the diodes are determined by voltages of the first and second capacitors and both ends of the first and second output capacitors. Therefore, in order to check the voltages of the above capacitors, FIG. 9 shows a circuit in the steady state. In DC steady state, the inductor is short-circuited and the capacitor becomes an open circuit. In this instance, relationship between voltages at both ends of each capacitor and input and output voltages is as follows.

Vi=Vc1+Vc2

Vo=Vo1+Vo2

In the first preferred embodiment of the present invention, if the first capacitor and the second capacitor have the same capacity, it achieves Vc1=Vc2=Vi/2.

In the second preferred embodiment of the present invention, if the first output capacitor and the second output capacitor have the same capacity, it achieves Vo1=Vo2=Vo/2.

[68] Here, the sentence that the capacitors have the same capacity does not mean that numerical values of the capacitors are perfectly the same. It may have an error range which may occur while the capacitors are manufactured, and capacitors in common use which are manufactured and sold with the same capacity correspond to capacitors with ‘identical capacity’.

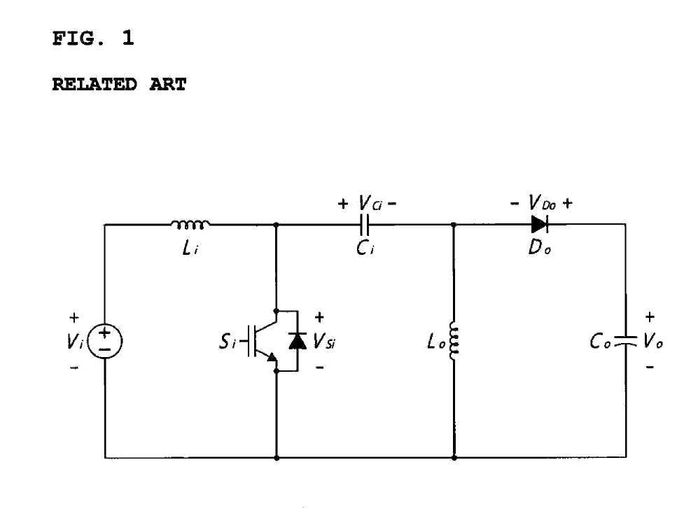

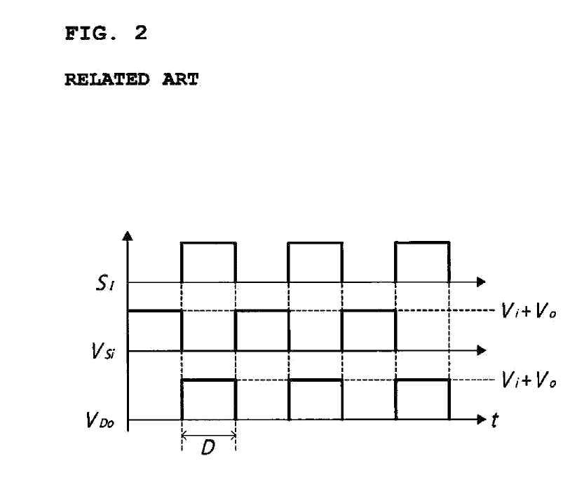

Therefore, voltages of the switches and both ends of the diodes become (Vi+Vo)/2. That is, compared with the structure shown in FIGS. 1 and 2, voltages applied to the switches and both ends of the diodes are reduced by half. Therefore, if input voltage and output voltage are high, the conventional converter circuit produces a lot of voltage stress, but the converter circuit according to the present invention can reduce switching power loss to under 25 percent.

FIG. 6 is a graph showing voltages of the diodes and the switches according to the operations of the switches in the converter circuit according to the preferred embodiment of the present invention. In this embodiment, interval of on-state duration of the first switch and the second switch is more than a half cycle but less than one cycle. That is, the duty cycle (D) exceeds 0.5.

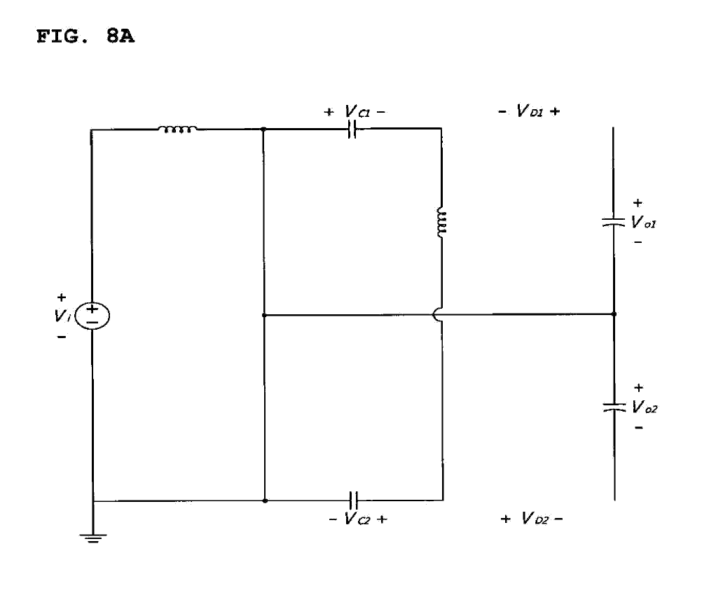

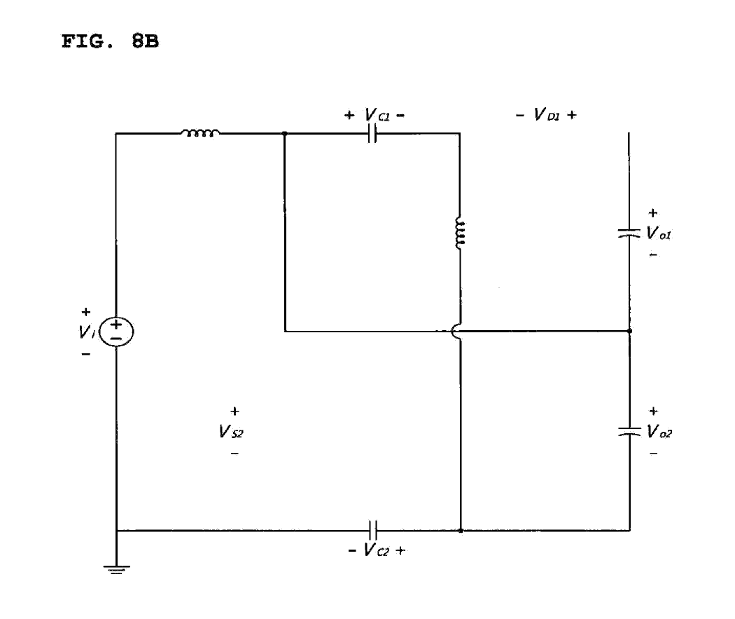

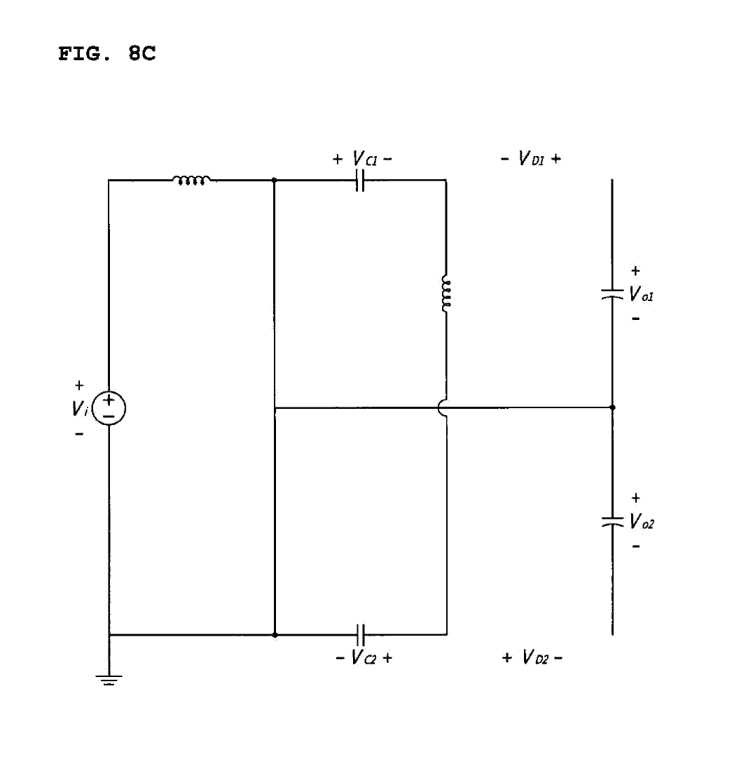

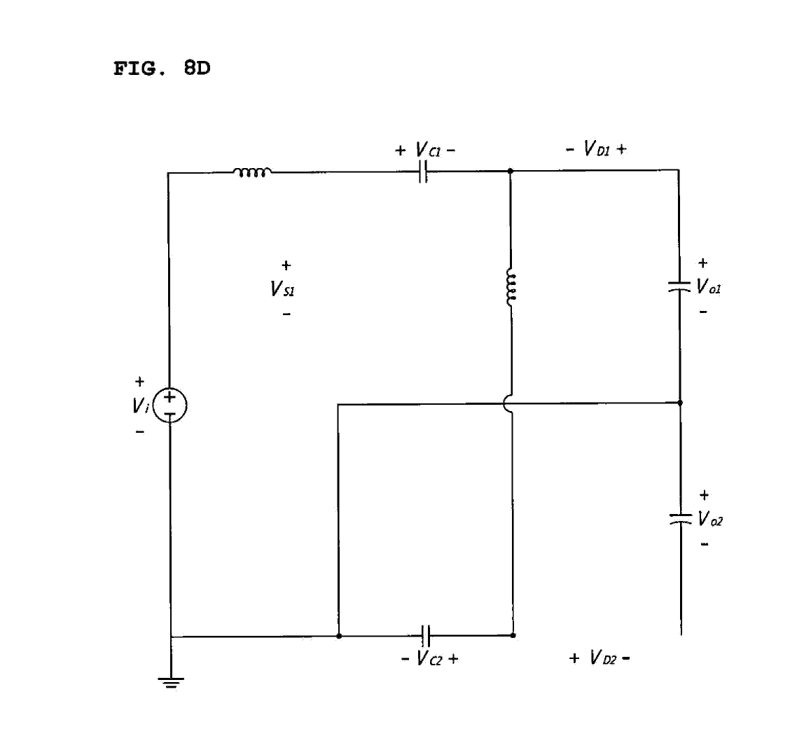

Referring to FIG. 6, at the time \textcircled{1}, the first switch and the second switch are all turned on. In this instance, operation of the three-level SEPIC converter circuit is as follows. The first diode and the second diode are all open. FIG. 8A shows the above state. In FIG. 8A, voltages applied to the first and second switches and the first and second diodes are as follows.

Vs1=0

Vs2=0

VD1=Vc1+Vo1

VD2=Vc2+Vo2

Because the first and second switches are short-circuited, voltage becomes zero and the voltage with the above-mentioned size in comparison with voltage of each element of the whole circuit is applied to the first and second diodes.

At the time \textcircled{2}, the first switch keeps the on state, but the second switch is turned off. In the meantime, in the above switched state, the first diode is open but the second diode is short-circuited. FIG. 8B shows the above state. In this instance, voltages applied to the first and second switches and the first and second diodes are as follows.

Vs1=0

Vs2=Vc2+Vo2

VD1=Vc1+Vo1

VD2=0

At the time \textcircled{3}, the first switch keeps the on state and the second switch is converted into the on state. In this instance, the first diode keeps the open state and the second diode is operated in an open state. FIG. 8C shows a circuit diagram of the above state. In this instance, voltages applied to the first and second switches and the first and second diodes are as follows.

Vs1=0

Vs2=0

VD1=Vc1+Vo1

VD2=Vc2+Vo2

At the time \textcircled{4}, the first switch is turned off and the second switch keeps the on state. In this instance, like the time \textcircled{2}, the first diode is open but the second diode is short-circuited. Voltages applied to the first and second switches and the first and second diodes are as follows.

Vs1=Vc1+Vo1

Vs2=0

VD1=0

VD2=Vc2+Vo2

Vs1, Vs2, VD1 and VD2 from the time \textcircled{1} to the time \textcircled{4} are 0 or Vc1+Vo1 or Vc2+Vo2.

As described above, in consideration of voltages of the capacitors in the steady state, as an operation result of the voltages by the times of the first and second switches and the first and second diodes, like the preferred embodiment shown in FIG. 5, the three-level SEPIC converter circuit according to the present invention reduced voltage by half compared with the conventional converter circuit, thereby reducing switching loss.

It will be understood by those of ordinary skill in the art that the above embodiments of the present invention are all exemplified and various changes, modifications and equivalents may be made therein without departing from the technical scope of the present invention as defined by the following claims.

What is claimed is:

1. A three-level SEPIC converter circuit comprising:
an input inductor which is connected to one side of an input terminal;
first and second switches which are connected between the input inductor and the other side of the input terminal in series;
a first capacitor and a first diode which are connected between the first switch and one side of an output terminal in series;
a second diode and a second capacitor which are connected between the other side of the output terminal and the other side of the input terminal in series; first and second output capacitors which are connected between the output terminals; and
an output inductor which is connected between a node between the first capacitor and the first diode and a node between the second capacitor and the second diode,
wherein a node between the first switch and the second switch and a node between the first output capacitor and the second output capacitor are connected, and
wherein the first capacitor is connected to the first switch, the first diode is connected to one side of an output terminal, the second capacitor is connected to the second switch and the second diode is connected to the other side of the output terminal.

2. The three-level SEPIC converter circuit according to claim 1, further comprising:
a control part for controlling on/off states of the first switch or the second switch.

3. The three-level SEPIC converter circuit according to claim 2, wherein the control part turns on or off the first switch and the second switch on a previously set cycle.

4. The three-level SEPIC converter circuit according to claim 3, wherein the control part controls the first switch and the second switch in such a way that there is a difference of a half cycle between the time that the first switch is turned on or off and the time that the second switch is turned on or off.

5. The three-level SEPIC converter circuit according to claim 4, wherein the control part controls the interval of on-state duration of the first switch and the second switch to be less than a half cycle.

6. The three-level SEPIC converter circuit according to claim 4, wherein the control part controls the interval of on-state duration of the first switch and the second switch to be more than a half cycle and less than one cycle.

7. The three-level SEPIC converter circuit according to claim 1, wherein an anode of the first diode is connected to the first capacitor and a cathode of the first diode is connected to one side of the output terminal.

8. The three-level SEPIC converter circuit according to claim 1, wherein an anode of the second diode is connected to the other side of the output terminal and a cathode of the second diode is connected to the second capacitor.

9. The three-level SEPIC converter circuit according to claim 1, wherein the first capacitor and the second capacitor have the same capacity.

10. The three-level SEPIC converter circuit according to claim 1, wherein the first output capacitor and the second output capacitor have the same capacity.
